(19) United States
(12) Patent Application Publication
(10) Pub. No.: US 2004/0202299 A1
(43) Pub. Date: Oct. 14, 2004

(54) Method and system for providing alternative media address information

(76) Inventor: Lisa Miller Schwartz, West Bloomfield, MI (US)

Correspondence Address: Paul M. Schwartz, Schwartz & Schwartz, P.L.C., Suite 200, 29623 Northwestern Highway, Southfield, MI, 48034, US

(21) Appl. No.: 09/790,081

(22) Filed: Feb. 21, 2001

(51) Int. Cl. H04M 11/00; H04M 1/64; H04M 3/00; H04M 5/00

(52) U.S. Cl. 379/142.01; 379/88.13; 379/88.2; 379/93.17; 379/245

(57) ABSTRACT

An method and system for providing automatic alternative media address information. The method is adapted for use in a communication network including a plurality of subscribers, each having at least one communication device for sending and/or receiving communications such as voice or data (facsimile, e-mail, video, optical, etc.). A network element receives an incoming communication from a calling party for a subscriber and an alternative media address signal is generated for receipt by the subscriber.

### TECHNICAL FIELD

This invention relates to a method and system for automatically providing alternative media address information for an incoming communication to a subscriber.

### BACKGROUND ART

The proliferation of affordable computing devices such as Personal Computers, Palm computers, Personal Digital Assistants, wireless telephones, Internet telephones, Internet appliances, and the like, has increased user dependence on the Internet as a means of sending and receiving communications. It has also blurred the functional distinctions between and among such devices, especially conventional telephones.

Wireless telephones such as cellular and PCS telephones, for example, now commonly include caller ID functionality. As those skilled in the art will recognize, caller ID is a telephone service which allows a person who is receiving a telephone call to determine the calling party before the call is answered. This is typically accomplished by the calling party transmitting with the telephone call identification information known as “digits” which comprise the name and/or calling number of the calling party. In addition to sending and receiving voice messages, conventional wireless telephones may also be used to access and browse the Internet and perform related functions such as sending and receiving e-mail. Television receivers may similarly be used to access the Internet as well as provide visual and/or textual alerts to users of incoming telephone calls and corresponding caller ID information. Still further, personal computers and Internet appliances equipped with Internet call waiting functionality, may be used to provide audio and/or visual indications to a user that there is an incoming telephone call on a common telephone line as well as provide caller ID information relating thereto.

As readily seen, despite the integration of the above computing devices and the blurring of their functional distinctions, all provide limited caller ID information to users. Specifically, this information has heretofore been limited to voice based address information. i.e. calling party telephone number and/or name.

Consequently, a need has developed for an automated method and system of providing alternative media address information for a user of a communication device in a communication network.

### DISCLOSURE OF INVENTION

It is a principal object of the present invention to provide an automated method and system for providing alternative media address information for a user of a communication device.

The method is specifically adapted for use in a communication network such as a telephone or computer network having at least one communication device for sending and/or receiving communications such as voice communications. The communication device may be any suitable device such as, for example, a telephone, a computer, a camera, a Personal Digital Assistant (PDA), etc. The method comprises receiving at a network element an incoming communication such as a telephone call from a calling party for a subscriber and generating an alternative media address signal for receipt by the subscriber. In the case of voice communications, for example, the alternative media address may comprise an e-mail address, a facsimile address, a video address, an optical address (e.g. wavelength) etc. In such manner, the subscriber may be provided alternative addresses to respond to the calling party in different mediums using the same or different devices. For example, a subscriber alerted at a computer of an incoming telephone call may be provided sufficient address information to respond to the calling party by e-mail or facsimile without interrupting the subscribers current computer session. Similarly, a subscriber alerted at a television of an incoming telephone call may likewise respond to the subscriber without interrupting the current viewing session. Even if concern for interrupting a current computer or television session is not an issue, the called party may still consider the alternative media information useful for later communications.

In carrying out the above method, there is provided a system for use in a communication network including a plurality of subscribers, each subscriber having at least one communication device. As indicated above, the communication device may comprise any suitable device including, but not limited to, a telephone, a computer, a PDA, a camera, etc. The system includes a datalog such as a database in communication with the network and having a plurality of calling numbers and corresponding alternative media addresses stored therein. The system further includes a network element in communication with the datalog for receiving an incoming call from calling party to a subscriber, determining a corresponding alternative media address and generating an alternative media address signal for receipt by the subscriber. In a preferred embodiment, the alternative media address may be determined by comparing the calling party's telephone number with the database. An alternative media address signal may thereafter be generated for receipt by the subscriber. The signal may comprise any suitable alternative address, including, but not limited to an e-mail address, a facsimile address, voice mail address, a video address, optical address (e.g. wavelength), a mailing address, a computer address, etc. provided that such address permits the subscriber to respond in a different medium from the received communication.

These and other objects, features and advantages of the present invention will become more readily apparent by reference to the following brief description of the drawings wherein like reference numerals correspond to like components.

### BRIEF DESCRIPTION OF DRAWINGS

FIG. 1 is a schematic diagram of a system for carrying out the method of the present invention;

FIG. 2 is a schematic diagram of representative correspondence generated by the method and system of the present invention; and

FIG. 3 is a block diagram of the method steps of the present invention.

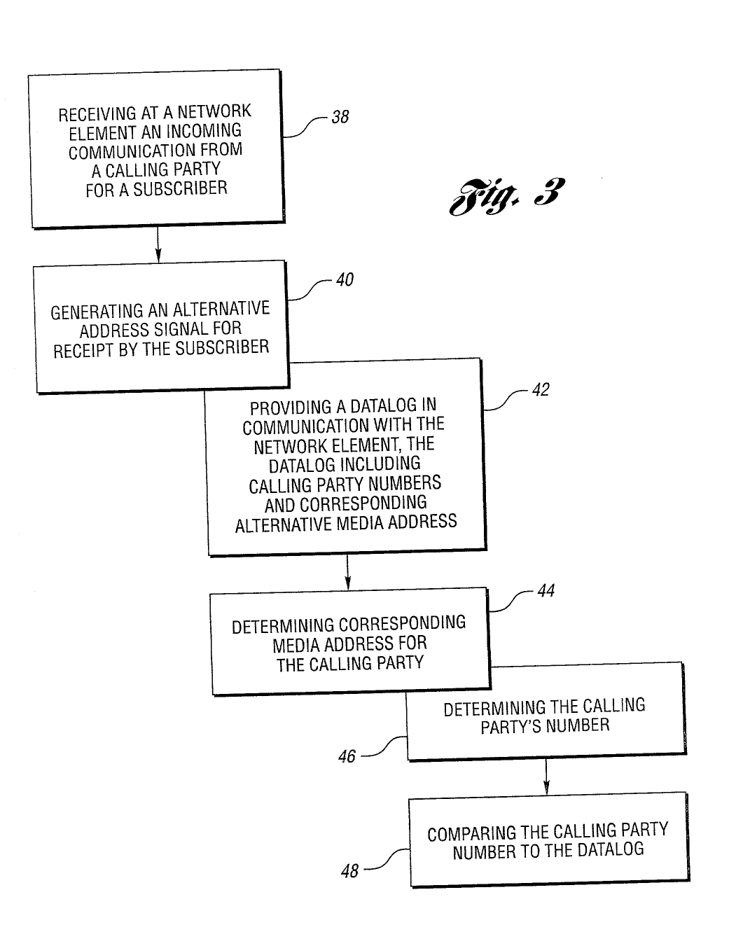

### BEST MODE FOR CARRYING OUT THE INVENTION

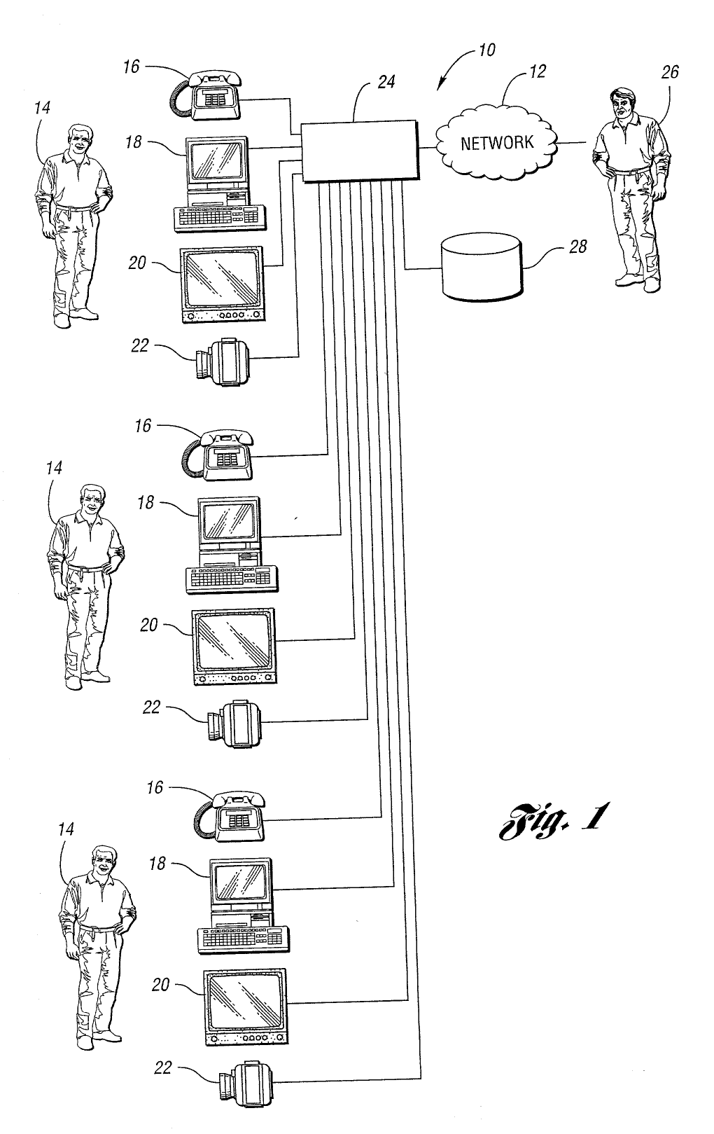

With reference to FIG. 1 of the drawings, there is shown a schematic diagram of the system for carrying out the method of the present invention which is designated by reference numeral 10. The method is specifically adapted for use in a communication network 12 having a plurality of subscribers 14. Network 12 may be any suitable network including, but not limited to, a telephone network such as a Plain Old Telephone System (POTS), an Advanced Intelligent Network (AIN), a wireless network, a cable network, an optical network, or any hybrid or combination thereof operative to provide voice and/or data communications. Each subscriber 14 has at least one communication device such as a wired or wireless telephone 16, a personal computer 18, a television 20, a Charge Coupled Device (CCD) such as a digital camera 22, or any other suitable device operative to send and/or receive communications including, without limitation, an internet appliance, a Personal Digital Assistant (PDA), a time piece, automobile computer, Palm computer, etc.

The system further includes a network element 24 such as, for example, a server, network node, a central office switch, a wired or wireless Service Control Point, an Integrated Service Control Point, or any suitable equivalent in communication with a calling party 26 and subscribers 14 for receiving an incoming communication such as a telephone call from calling party 26 for a subscriber 14 (a called party). In keeping with the invention, calling party 26 similarly communicates with a suitable communication device operative to send and/or receive voice and/or data communications including, but not limited to, the devices identified above. The system further includes a datalog such as a database 28 in communication with the network element 24 and including a plurality of calling party addresses such as voice mail addresses (calling party telephone numbers), facsimile addresses, e-mail addresses, video addresses, optical addresses etc and corresponding alternative media addresses. For example, database 28 may include a calling party's telephone number as well as the calling party's facsimile address and mailing address all suitably cross referenced and linked to one another.

In keeping with the invention, the network element 24 functions to receive a communication from a calling party 26 to a subscriber 14, determine the calling party's calling number, determine one or more corresponding alternative media addresses for the calling party 26 and generate one or more alternative media address signals for receipt by the subscriber 14. In a preferred embodiment, the network element 24 performs this function by comparing the calling party number of the calling party 26 to the database to locate corresponding stored alternative media addresses. Thus, if the communication is a voice communication, the calling party telephone number may be compared to calling party telephone numbers in database 28 to locate the corresponding alternative media addresses such as facsimile addresses, e-mail addresses, computer addresses, URL, mailing addresses etc. stored therein. Such addresses may be provided to the subscriber 14 as part of the alternative media address signal to permit the subscriber to respond to the voice communication in one or more alternative mediums.

For example, as indicated above, a user 14 in an active computer session, may be alerted on her computer screen 18 of an incoming telephone call from a calling party 26 having an identified telephone number, name, e-mail address and facsimile address. The user 14 may, accordingly, respond to the telephone call by generating and sending an e-mail message or facsimile to the calling party 26 at the identified address. Of course, the same user may also be alerted on her computer screen of an incoming e-mail message, voice mail message, or facsimile message from a calling party 26 having an identified e-mail address, facsimile address, and/or telephone number etc. The user may, accordingly, respond to the message by generating and sending a facsimile message, an e-mail message, or a telephone call, respectively at the corresponding addresses. By way of further example, a wired or wireless telephone user 14 engaged in a telephone call may be alerted on a suitable display (not shown) to an incoming telephone call from a calling party 26 having an identified e-mail address. In accordance with the invention, the user may generate a responsive e-mail message. Of course, the same user may be alerted to an incoming e-mail message from a calling party having an identified telephone number. The user may, accordingly, choose simply to call the calling party at the identified calling number. The uses of the invention, are of course, limited only by the imagination provided only that the subscriber is given sufficient address information to respond to a communication in real time or a later time in a medium different from the incoming communication.

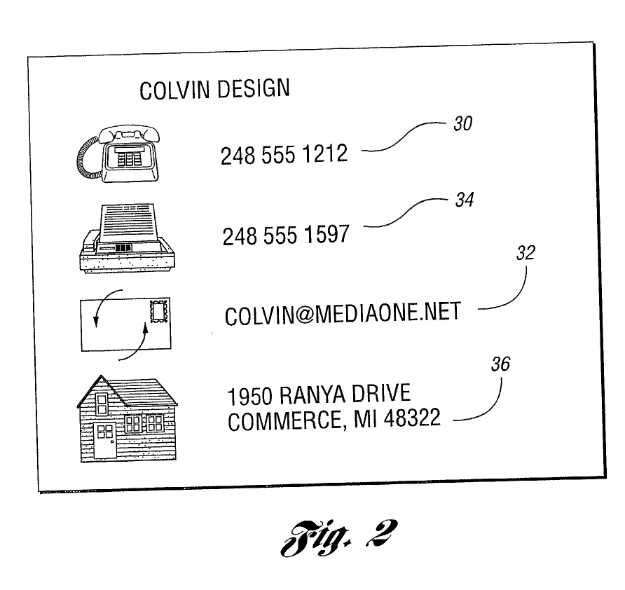

A schematic of representative alternative media address information is shown in FIG. 2. In keeping with the invention, such information may be decoded from an alternative media address signal for display on a user display such as a telephone, computer monitor, television, or other suitable display of a computing device such as a camera, PDA, time piece, etc. The address information includes the address of the originating communication in the given medium as well as alternative addresses in different mediums for a subscriber to reply to. In the example shown, it is therefore understood that the originating communication is a voice communication. Accordingly, the calling party's calling number 30 is displayed. The calling party's alternative addresses i.e. e-mail address 32, facsimile address 34, conventional mail address 36, as well as any other suitable address may also be provided. Such addresses may, of course, correspond to receiving devices co-located with the calling party or at remote physical addresses. For example, the calling party may have stored in his or her profile in database 28 a facsimile address at an office, a voice mail or voice communication address (calling number) at home etc.

The information may, of course, be displayed in any suitable manner. For example, in the schematic shown, representative icons are used to designate telephone, fax, e-mail and mailing addresses. It is understood, however, that text may also be used in place of or in addition to the use of such icons. Sill further, different colors, highlighting, or other visual indication may be used to designate the medium of the incoming call or the availability of the alternative addresses listed. For example, the icon or text corresponding to the medium of the incoming communication may blink or be designated by default to be a specified color such as blue. Still further, the system may provide all icons or text corresponding to available mediums in green and unavailable mediums in red. Thus, if an incoming communication is a telephone call and the system determines that the calling party's fax receiving equipment is currently busy or otherwise not available, the display may provide the telephone icon and/or text in a blinking condition, provide the fax icon and/or text in red, and the e-mail and house icons and/or text in green.

Turning now to FIG. 4 of the drawings, the generalized method steps of the present invention are shown in further detail. The method includes receiving 38 at a network element an incoming communication from a calling party for a subscriber. The method further includes generating 40 an alternative media address signal for receipt by the subscriber. As shown, in a preferred embodiment, the method further comprises providing 42 a datalog in communication with the network element, the datalog including calling party numbers and corresponding alternative media addresses. The method further includes determining 44 corresponding media address information for the calling party. Still further, in the preferred embodiment, the step of determining corresponding alternative media address information for the calling party includes determining 46 the calling party's calling number, and comparing 48 the calling party's calling number to the datalog.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. For use in a communication network including a plurality of subscribers, each subscriber having at least one communication device for sending and/or receiving voice communications, a method of providing automatic alternative media address information, comprising:
receiving at a network element an incoming telephone call from a calling party for a subscriber; and
generating an alternative media address signal for receipt by the subscriber.

2. A method as in claim 1, wherein the alternative media address signal comprises an e-mail address for the calling party.

3. A method as in claim 1, wherein the alternative media address signal comprises a facsimile address for the calling party.

4. A method as in claim 1, wherein the alternative media address signal comprises a video address for the calling party.

5. A method as in claim 1, wherein the communication device is selected from the group comprising a telephone, a television, a wireless device, a computer, a camera, a charge coupled device, a Personal Digital Assistant (PDA), a time piece and a web browser.

6. A method as in claim 1, wherein the network element comprises a computer.

7. A method as in claim 1, wherein the communication network comprises a telephone network.

8. A method as in claim 1, wherein the communication network comprises the Internet.

9. A method as in claim 1, wherein the subscriber communication device is operative to decode the alternative media address signal.

10. A method as in claim 1, further comprising:
providing a database in communication with the network, the database including calling party telephone numbers and corresponding alternative media addresses; and
determining corresponding alternative media address information for the calling party.

11. A method as in claim 10, wherein the step of determining corresponding alternative media address information for the calling party comprises:
determining the calling party's calling number; and
comparing the calling party's calling number to the database.

12. A method as in claim 10, wherein the alternative media address information is selected from the group comprising e-mail addresses, facsimile addresses, video addresses, user addresses, voice mail addresses, and computer addresses.

13. For use in a telephone network comprising a plurality of subscribers, each subscriber having at least one communication device for sending and/or receiving voice communications, a method of providing automatic e-mail address information, comprising:
providing a database comprising a plurality of calling party numbers and corresponding e-mail addresses;
receiving at a network element an incoming telephone call from a calling party to a subscriber;
determining the calling number of the calling party;
comparing the calling number to the database to determine the corresponding e-mail address of the calling party; and
generating an e-mail address signal for receipt by the subscriber.

14. A method as in claim 13, wherein the subscriber's communication device is operative to decode the e-mail address information signal.

15. For use in a communication network including a plurality of subscribers, each subscriber having at least one communication device for sending and/or receiving voice communications, a system for providing automatic alternative address information, comprising:
a database in communication with the network, the database including a plurality of calling party numbers and corresponding alternative media addresses;
a network element in communication with the database for receiving an incoming call from a calling party to a subscriber and generating an alternative media address signal for receipt by the subscriber.

16. A system as in claim 15, wherein the communication network is a telephone network.

17. A system as in claim 15, wherein the communication network is the Internet.

18. A system as in claim 15, wherein the alternative media addresses are selected from the group comprising e-mail addresses, facsimile addresses, user addresses, video addresses, voice mail addresses, and computer addresses.

19. A system as in claim 15, wherein the network element is further operative to compare the calling party's calling party number to the database to determine the corresponding alternative media addresses.

20. A system as in claim 15, wherein the subscriber's communication device is operative to decode the alternative media address signal.

21. For use in a communication network including a plurality of subscribers, each subscriber having at least one communication device for sending and/or receiving communications, a method of providing automatic alternative media address information, comprising:
receiving at a network element an incoming communication from a calling party for a subscriber, the communication provided in a first medium; and
generating an alternative media address signal for receipt by the subscriber,
wherein the subscriber may respond to the calling party in a second and different medium.

22. A method as in claim 21, wherein the communication device is selected from the group comprising a telephone, a computer, a wireless device, a Personal Digital Assistant (PDA), a television, a camera, a charge coupled device, a time piece, and a web browser.

23. For use in a communication network including a plurality of subscribers, each subscriber having at least one communication device for sending and/or receiving communications, a system for providing automatic alternative address information, comprising:
a database in communication with the network, the database including a plurality of calling party numbers and corresponding alternative media addresses;
a network element in communication with the database for receiving an incoming communication from a calling party to a subscriber in a first medium and generating an alternative media address signal for receipt by the subscriber;
wherein the subscriber may respond to the calling party in a second and different medium.

24. A method as in claim 23, wherein the communication device is selected from the group comprising a telephone, a computer, a wireless device, a Personal Digital Assistant (PDA), a television, a camera, a charge coupled device, a time piece, and a web browser.
